(19) United States
(12) Patent Application Publication
(10) Pub. No.: US 2022/0319013 A1
(43) Pub. Date: Oct. 6, 2022

(54) IMAGE PROCESSING DEVICE, IMAGE PROCESSING METHOD, AND PROGRAM

(71) Applicant: SONY GROUP CORPORATION, TOKYO (JP)

(72) Inventor: KEITARO YAMAMOTO, TOKYO (JP)

(21) Appl. No.: 17/596,687

(22) PCT Filed: May 26, 2020
(86) PCT No.: PCT/JP2020/020715

§ 371 Date: Dec. 16, 2021

(30) Foreign Application Priority Data
Jun. 25, 2019 (JP) 2019-117125

(51) Int. Cl. G06T 7/20

(52) U.S. Cl. CPC G06T 7/20; G06T 2207/10144

(57) ABSTRACT

A first imaging section 21r of a rolling shutter mode which is configured to perform exposure of lines at different timings and a second imaging section 21g of a global shutter mode which is configured to perform exposure of lines at one timing capture images of a subject that is moving. By using a second captured image obtained by the second imaging section 21g, a distortion calculating section 33 determines a subject image distortion generated in a first captured image obtained by the first imaging section 21r. A moving-speed detecting section 35 detects the moving speed of the subject in each line, on the basis of the view angle of the captured image, the distortion amount of the image distortion determined by the distortion calculating section 33, and the distance to the subject measured by a distance measuring section 34. Accordingly, the moving speed of the subject can be detected quickly and frequently.

### TECHNICAL FIELD

The present technology relates to an image processing device, an image processing method, and a program. With the present technology, the moving speed of a subject can be detected quickly and frequently.

### BACKGROUND ART

The Doppler effect has conventionally been used to detect the moving speed of a moving object. Waves resulting from reflection of radio waves or ultrasonic waves applied to a moving object have been used to detect the moving speed. In addition, in PTL 1, the moving speed of a moving object is detected on the basis of a captured image of the moving object.

### CITATION LIST

### Patent Literature

[PTL 1]
Japanese Patent Laid-Open No. 2001-183383

### SUMMARY

### Technical Problem

Meanwhile, in PTL 1, the moving speed is calculated on the basis of a position change of a subject between captured image frames and a captured image frame rate, etc. The moving speed of the subject cannot be detected at a speed and frequency higher than the frame rate.

In view of this, an object of the present technology is to provide an image processing device, an image processing method, and a program for enabling quick and frequent detection of the moving speed of a subject.

### Solution to Problem

A first aspect of the present technology is an image processing device including a moving-speed detecting section that detects a moving speed of a subject on the basis of a subject image distortion generated in a first captured image obtained by exposure of lines at different timings.

In this technology, the subject image distortion generated in the first captured image obtained by a first imaging section that performs exposure of lines at different timings is determined on the basis of a second captured image obtained by a second imaging section that performs exposure of lines at one timing, and the moving speed of the subject in each line, for example, is detected by the moving-speed detecting section on the basis of a distortion amount of the determined image distortion, a view angle of the first captured image, and a distance to the subject measured by a distance measuring section.

The first imaging section and the second imaging section are disposed in such a way that the parallax between the first captured image and the second captured image is less than a predetermined value and that the first captured image and the second captured image are equal in pixel size of the region of the same subject.

A distortion calculating section configured to calculate a subject image distortion calculates the distortion amount by using the amount of a position deviation between line images of the subject in an identical position in the first captured image and the second captured image. For example, the difference between the amount of a position deviation between line images of the subject in a first position in the first captured image and the second captured image and an amount of a position deviation between line images of the subject in a second position, at which the exposure timing is later than that at the first position, in the first captured image and the second captured image is used as the distortion amount. Further, the distortion calculating section may adjust a line interval between the first position and the second position according to the size of the subject image. Alternatively, the distortion calculating section may calculate the distortion amount on the basis of a geometric transformation as a result of which the difference between the first captured image and a geometrically transformed image generated by a geometric transformation process on the second captured image becomes equal to or less than a predefined threshold.

In addition, an object recognizing section that performs subject recognition with use of the second captured image and that identifies an image region of a speed detection target the moving speed of which is to be detected is provided. The distortion calculating section calculates the image distortion by using an image of the image region of the speed detection target identified by the object recognizing section. Further, the distortion calculating section calculates respective image distortions of plural the speed detection targets identified by the object recognizing section, while switching the speed detection targets in units of lines, and the moving-speed detecting section detects the moving speed of each of the speed detection targets in units of lines on the basis of the image distortions sequentially calculated by the distortion calculating section. Further, the object recognizing section detects a still object as the speed detection target, and the moving-speed detecting section detects a moving speed relative to the still object on the basis of a distortion amount of an image distortion of the still-object.

A second aspect of the present technology is an image processing method including causing a moving-speed detecting section to detect a moving speed of a subject on the basis of a subject image distortion generated in a first captured image obtained by exposure of lines at different timings.

A third aspect of the present technology is a program for causing a computer to detect a moving speed by using a captured image. The program causes the computer to execute a procedure of acquiring a first captured image obtained by exposure of lines at different timings, a procedure of calculating a subject image distortion generated in the first captured image, and a procedure of detecting a moving speed of the subject on the basis of the calculated image distortion.

It is to be noted that the program according to the present technology can be provided by a storage medium or communication medium, for example, a storage medium such as an optical disk, a magnetic disk, or a semiconductor memory or a communication medium such as a network, for providing the program in a computer readable format to a general-purpose computer that is capable of executing various program codes, for example. Since the program is provided in a computer readable format, processing in accordance with the program is executed on the computer.

### BRIEF DESCRIPTION OF DRAWINGS

FIG. 1 depicts diagrams for explaining a global shutter mode and a rolling shutter mode.

FIG. 2 depicts diagrams illustrating distortions that are generated in a case where the rolling shutter mode is used.

FIG. 3 is a diagram illustrating the configuration of a speed detection system.

FIG. 4 depicts diagrams illustrating arrangement of an imaging section 21g and an imaging section 21r.

FIG. 5 is a diagram illustrating a flowchart of a first operation.

FIG. 6 is a diagram for explaining an operation of a moving-speed detecting section.

FIG. 7 depicts diagrams illustrating the first operation.

FIG. 8 depicts diagrams illustrating signals of a base line and a reference line.

FIG. 9 is a diagram illustrating an operation in a case where there are plural moving objects.

FIG. 10 depicts diagrams illustrating a case in which an imaging device is mounted on a side surface of a mobile object.

FIG. 11 is a diagram illustrating a flowchart of a second operation.

FIG. 12 is a diagram illustrating a subject which is coming close to the imaging device.

FIG. 13 is a diagram for explaining calculation of a moving speed.

FIG. 14 is a block diagram illustrating a schematic functional configuration example of a vehicle control system.

### DESCRIPTION OF EMBODIMENT

Hereinafter, a mode for implementing the present technology will be explained. It is to be noted that the explanation will be given in the following order.

1. Speed Detection according to Present Technology

2. Configuration in Embodiment

3. Operations in Embodiment
3-1. First Operation
3-2. Second Operation
3-3. Other Operations

4. Application Examples

### 1. SPEED DETECTION ACCORDING TO PRESENT TECHNOLOGY

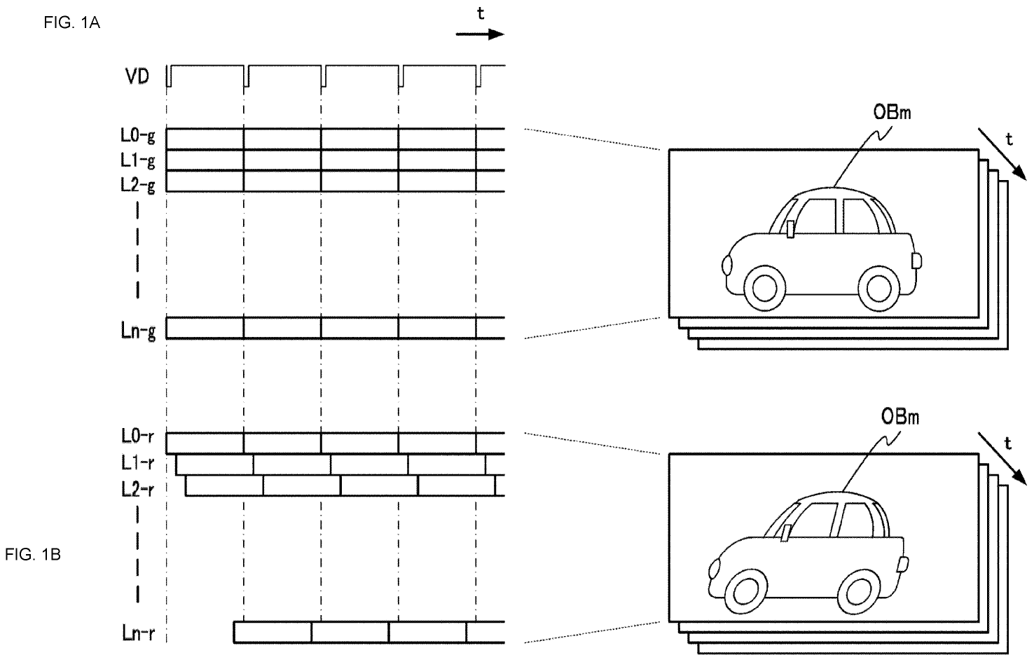

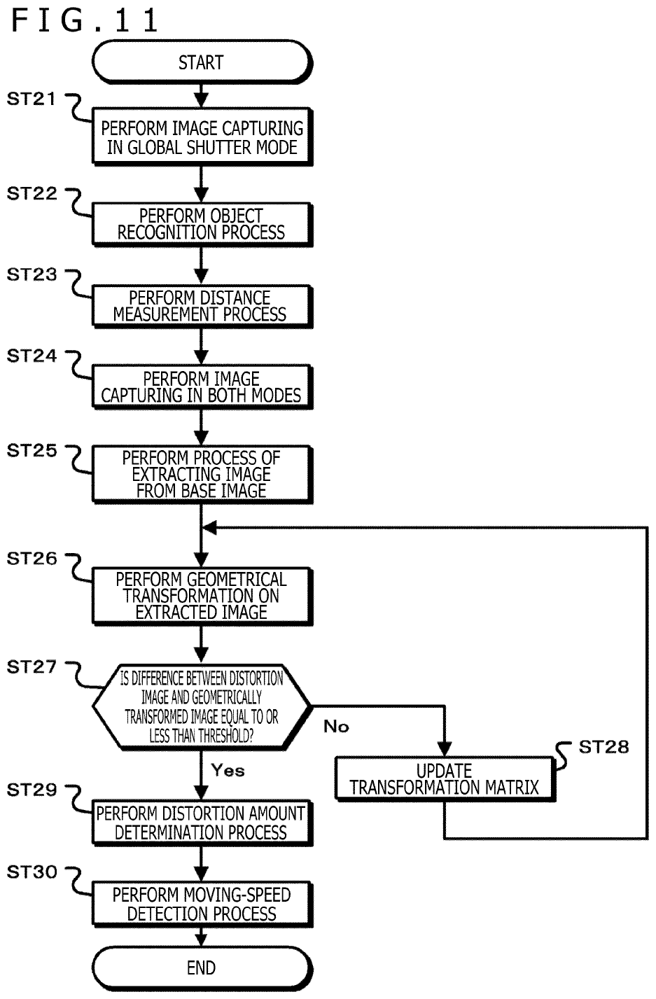

FIG. 1 depicts diagrams for explaining a global shutter mode and a rolling shutter mode. In FIG. 1, (a) illustrates an operation of a solid-state imaging device using a global shutter mode. The global shutter mode performs exposure of lines L0-g to Ln-g at one timing that is based on a vertical drive signal VD, so that captured images are acquired in units of frames. In FIG. 1, (b) illustrates an operation of a solid-state imaging device using a rolling shutter mode. The rolling shutter mode performs exposure of the first line L0-r with respect to a vertical drive signal VD, and performs exposure of the second and subsequent lines L1-r to Ln-r at different timings for the respective lines, so that captured images are acquired in units of frames. Thus, in a case where a subject is moving, a subject image distortion is generated in captured images. Furthermore, the distortion varies according to the moving speed of the subject. When the moving speed is high, the distortion becomes large. It is to be noted that, in FIG. 1 and FIG. 11 which is to be described later, a time direction is indicated by an arrow t.

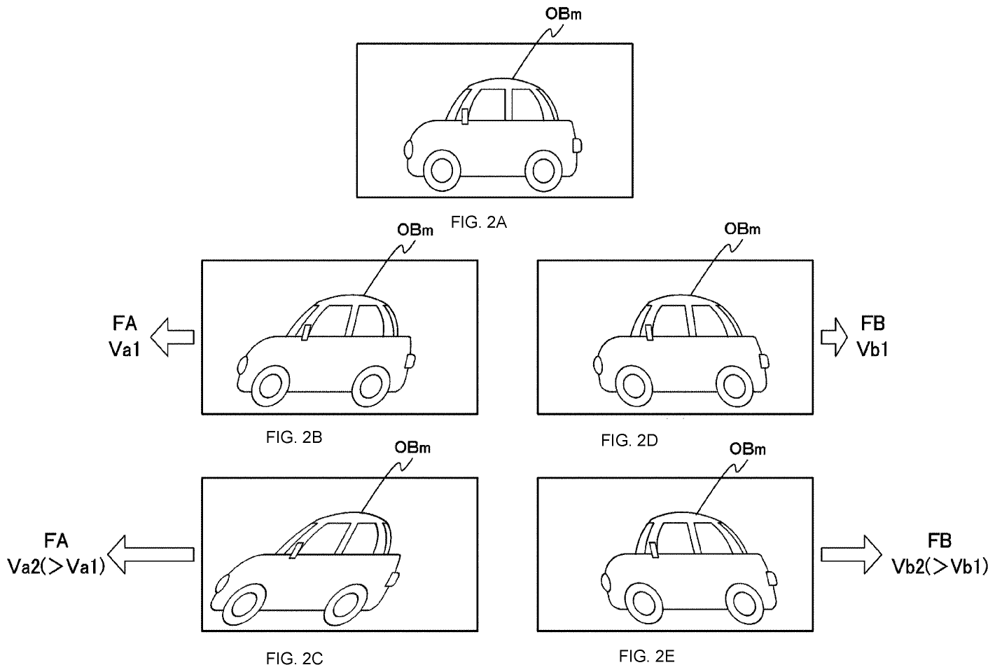

FIG. 2 illustrates distortions that are generated in a case where the rolling shutter mode is used. In FIG. 2, (a) illustrates a captured image that is obtained in a case where a subject OB is in a stationary state. In FIG. 2, (b) illustrates a captured image that is obtained in a case where the subject OB is moving in the direction of an arrow FA at a moving speed Va1. In FIG. 2, (c) illustrates a captured image that is obtained in a case where the subject OB is moving in the direction of the arrow FA at a moving speed Va2 (>Va1). Further, in FIG. 2, (d) illustrates a captured image that is obtained in a case where the subject OB is moving in the direction of an arrow FB at the moving speed Vb1. In FIG. 2, (e) illustrates a captured image that is obtained in a case where the subject OB is moving in the direction of the arrow FB at the moving speed Vb2 (>Vb1).

As illustrated in the drawings, in a captured image obtained by a solid-state imaging device using the rolling shutter mode, an image distortion is generated according to movement of a subject. Thus, an image processing device according to the present technology detects the moving speed of a subject on the basis of a subject distortion generated in a captured image. Specifically, from a captured image (hereinafter, referred to as a “non-distortion image”) in which no image distortion is generated according to movement of a subject, as illustrated in (a) of FIG. 1 and a captured image (hereinafter, referred to as a “distortion image”) in which an image distortion is generated according to movement of the subject, as illustrated in (b) of FIG. 1, the moving speed of the subject is calculated quickly and frequently on the basis of the amount of the distortion generated in the distortion image. For example, the position deviation amount of the subject in each line is calculated, and the moving speed of the subject in each line is calculated on the basis of the calculated position deviation amount.

### 2. CONFIGURATION IN EMBODIMENT

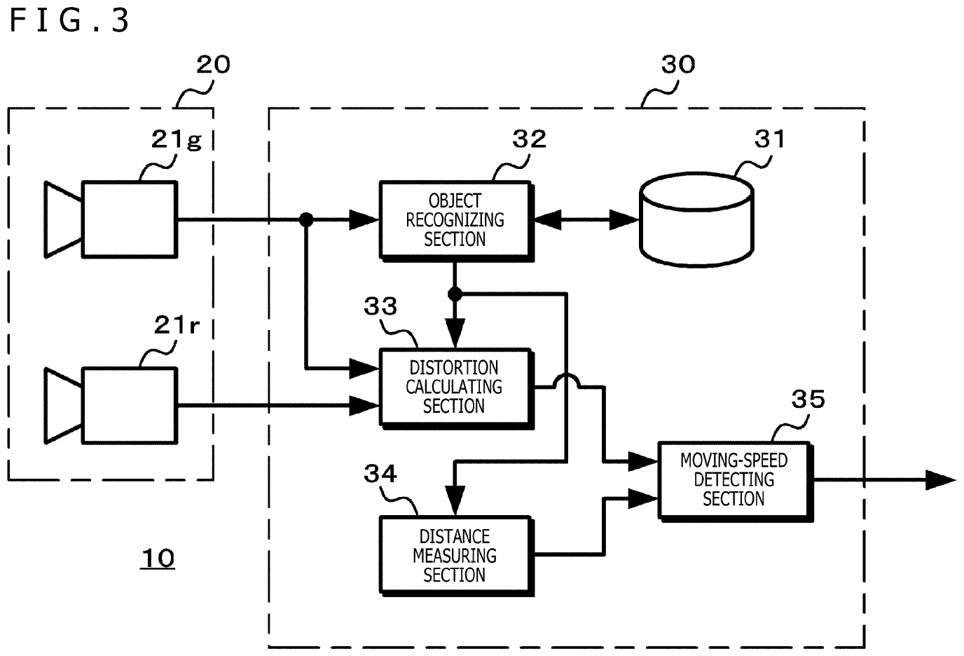

FIG. 3 illustrates the configuration of a speed detection system using an image processing device according to the present technology. A speed detection system 10 includes an imaging device 20 that captures an image of a subject and an image processing device 30 that detects the moving speed of a subject on the basis of a captured image obtained by the imaging device 20.

The imaging device 20 includes an imaging section (first imaging section) 21r of the rolling shutter mode and an imaging section (second imaging section) 21g of the global shutter mode. The imaging section 21r of the rolling shutter mode includes a CMOS image sensor, for example. The imaging section 21g of the global shutter mode includes a global shutter CMOS image sensor or a CCD (Charge Coupled Device) image sensor, for example.

The imaging section 21r and the imaging section 21g are disposed in such a way that the image processing device 30, which will be described later, can easily calculate a subject image distortion generated in a distortion image (first captured image) obtained by the imaging section 21r, on the basis of a non-distortion image (second captured image) obtained by the imaging section 21g. For example, the imaging section 21r and the imaging section 21g are disposed in such a way that the parallax between a distortion image obtained by the imaging section 21r and a non-distortion image obtained by the imaging section 21g is less than a predetermined value and that the first captured image and the second captured image are equal in pixel size of the region of the same subject.

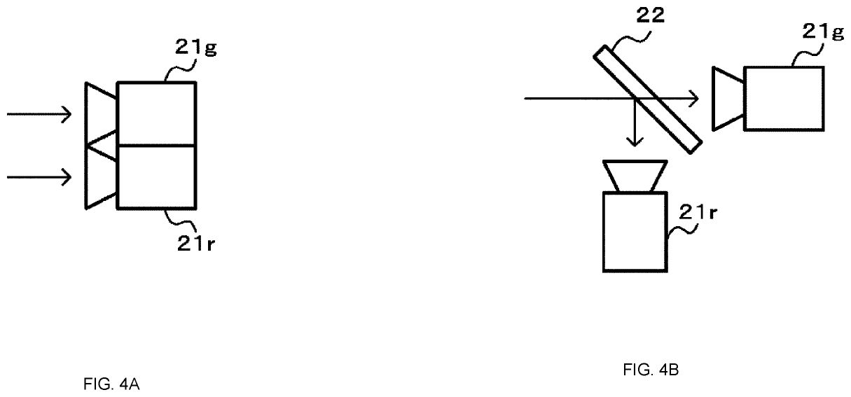

FIG. 4 illustrates arrangement of the imaging section 21g and the imaging section 21r. In FIG. 4, (a) illustrates a case where the imaging section 21g and the imaging section 21r are disposed side by side in such a way that the parallax between a distortion image and a non-distortion image becomes ignorable. In addition, in FIG. 4, (b) illustrates a case where, on the light path of subject light to be incident on either one of the imaging section 21g or the imaging section 21r, a half mirror 22 is disposed to cause the subject light to enter the other imaging section, so that no parallax is generated between a distortion image and a non-distortion image. Here, in a case where imaging section 21g and the imaging section 21r have the same imaging optical system and number of effective pixels of an image sensor, for example, the position and region size of an image of a subject that is in a stationary state are the same in a distortion image and a non-distortion image. In this case, in a case where a subject image distortion is generated due to movement of the subject, the amount of the distortion can easily be calculated.

A non-distortion image obtained by the imaging section 21g of the global shutter mode and a distortion image obtained by the imaging section 21r of the rolling shutter mode are outputted from the imaging device 20 to the image processing device 30.

As illustrated in FIG. 3, the image processing device 30 includes a database section 31, an object recognizing section 32, a distortion calculating section 33, a distance measuring section 34, and a moving-speed detecting section 35.

Registration information such as data regarding the shape of a target (subject) the moving speed of which is to be detected is preliminarily registered in the database section 31. The object recognizing section 32 identifies a moving-speed detection target on the basis of the non-distortion image supplied from the imaging device 20 and the registration information in the database section 31, and specifies the image region of the detection target as a process target region. The object recognizing section 32 outputs information indicating the specified process target region to the distortion calculating section 33 and the distance measuring section 34.

The distortion calculating section 33 calculates an image distortion of the detection target in each line in the distortion image, by using an image of the process target region in the non-distortion image identified by the object recognizing section 32. The distortion calculating section 33 outputs the distortion amounts calculated in the respective lines to the moving-speed detecting section 35.

The distance measuring section 34 measures the distance to the detection target by using either a passive method or an active method. For example, in a case where the passive method is used, the distance measuring section 34 forms, respectively on a pair of line sensors, one of split images and the other split image obtained by pupil split, and measures the distance to the detection target on the basis of the phase difference between the images formed on the line sensors. Alternatively, an image plane phase difference detection pixel for separately generating an image signal of one of split images and an image signal of the other split image, the split images being obtained by pupil split, may be provided in an image sensor that the imaging device 20 uses, and the distance measuring section 34 may measure the distance to the detection target on the basis of the image signals generated by the image plane phase difference detection pixel. In a case where the active method is used, the distance measuring section 34 emits light or radio waves, and measures the distance to the detection target on the basis of reflected light or radio waves. For example, the distance measuring section 34 measures the distance by using a TOF (Time of Flight) sensor, a LiDAR (Light Detection and Ranging, Laser Imaging Detection and Ranging), a RADAR (Radio Detection and Ranging), or the like. The distance measuring section 34 outputs the measurement result of the distance to the detection target recognized by the object recognizing section 32, to the moving-speed detecting section 35.

The moving-speed detecting section 35 detects the moving speed of the detection target (subject) on the basis of the image distortions of the detection target calculated by the distortion calculating section 33. The moving-speed detecting section 35 detects the moving speed of the detection target on the basis of the image distortions in a manner explained later, by using information regarding the image capturing conditions (e.g., view angles and resolutions) of the imaging sections 21g and 21r and the distance to the detection target measured by the distance measuring section 34.

### 3. OPERATIONS IN EMBODIMENT

<3-1. First Operation>

Next, a first operation according to the embodiment will be explained. In the first operation, an image of a process target region in each line is extracted, the amount of the position deviation of the detection target region between an image extracted from the non-distortion image and the corresponding image extracted from the distortion image is used to calculate a distortion amount, and the moving speed of the detection target in each line is detected on the basis of the calculated distortion amount.

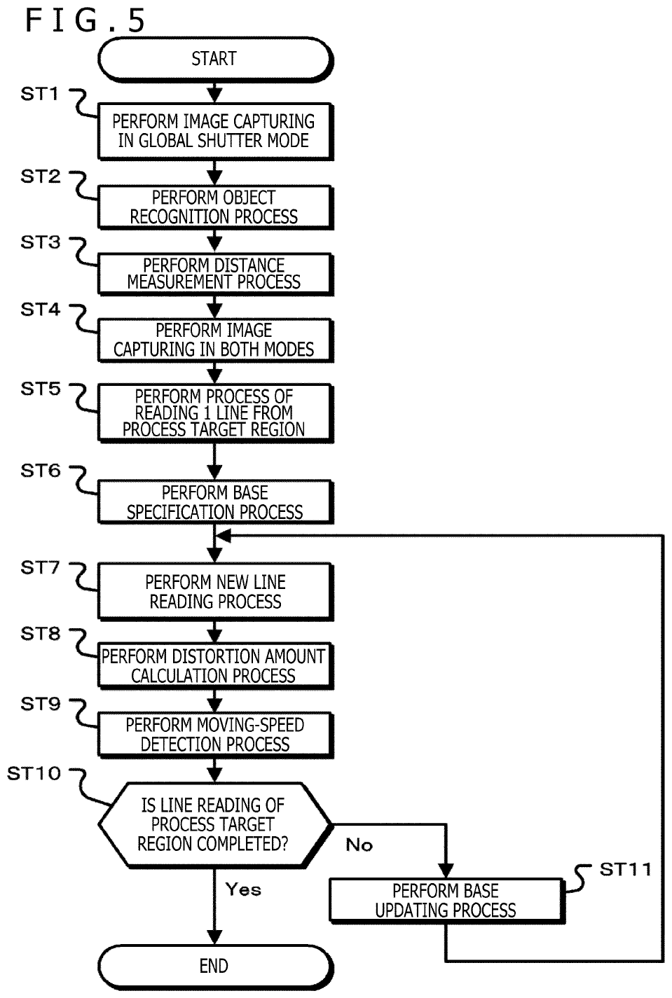

FIG. 5 illustrates a flowchart of the first operation. In step ST1, the imaging device performs image capturing in a global shutter mode. The imaging device 20 performs image capturing by means of the imaging section 21g of a global shutter mode, and acquires a captured image. Then, the flow proceeds to step ST2.

In step ST2, the image processing device performs an object recognition process. The object recognizing section 32 of the image processing device 30 recognizes an object included in the captured image obtained in step ST1, and detects a detection target the moving speed of which is to be detected. Then, the flow proceeds to step ST3.

In step ST3, the image processing device performs a distance measuring process. The distance measuring section 34 of the image processing device 30 measures the distance to the detection target detected in step ST2. Then, the flow proceeds to step ST4.

In step ST4, the imaging device performs image capturing in both modes. The imaging device 20 performs image capturing by means of both the imaging section 21g of the global shutter mode and the imaging section 21r of the rolling shutter mode, and acquires a non-distortion image and a distortion image. Then, the flow proceeds to step ST5.

In step ST5, the image processing device performs a process of 1-line reading from a process target region. From each of the non-distortion image and the distortion image, the distortion calculating section 33 of the image processing device 30 reads out a 1-line image, at an identical position, of the detection target detected in step ST2. Then, the flow proceeds to step ST6.

In step ST6, the image processing device performs a base specification process. The distortion calculating section 33 of the image processing device 30 specifies, as a base line La, a line that is located at a first position where the image reading has been performed in step ST5. In addition, the distortion calculating section 33 calculates the amount of the position deviation between the image of the base line La read out from the non-distortion image and the image of the base line La read out from the distortion image. For example, the image of the base line read out from the distortion image is shifted by unit of pixel, the difference from the image of the base line read out from the non-distortion image is calculated, and a shift amount by which the difference becomes minimum is specified as a base deviation amount EPa. Then, the flow proceeds to step ST7.

In step ST7, the image processing device performs a new line reading process. The distortion calculating section 33 of the image processing device 30 specifies, as a reference line Lb, a line (hereinafter, referred to as a “reference line”) located at a second position, which is different from the base line at the first position. For example, in a case where a shift of a readout line is made downwardly, the distortion calculating section 33 specifies, as the reference line Lb, a line directly under the base line, and reads out an image of the reference line Lb from each of the non-distortion image and the distortion image. Then, the flow proceeds to step ST8.

In step ST8, the image processing device performs a distortion amount calculation process. The distortion calculating section 33 calculates, as a distortion amount, the amount of the position deviation between the line images read out from the non-distortion image and the distortion image in step ST7. For example, the image of the reference line Lb read out from the distortion image is shifted by unit of pixel, the difference from the image of the reference line Lb read out from the non-distortion image is calculated, and a shift amount by which the difference becomes minimum is specified as a position deviation amount EPb. Then, the flow proceeds to step ST9.

In step ST9, the image processing device performs a moving speed detection process. The moving-speed detecting section 35 of the image processing device 30 detects the moving speed of the detection target on the basis of the distance d to the detection target measured in step ST2, the base deviation amount EPa calculated in step ST6, the position deviation amount EPb calculated in step ST8, and information regarding predefined image capturing conditions (e.g., view angles and resolutions) of the imaging sections 21g and 21r.

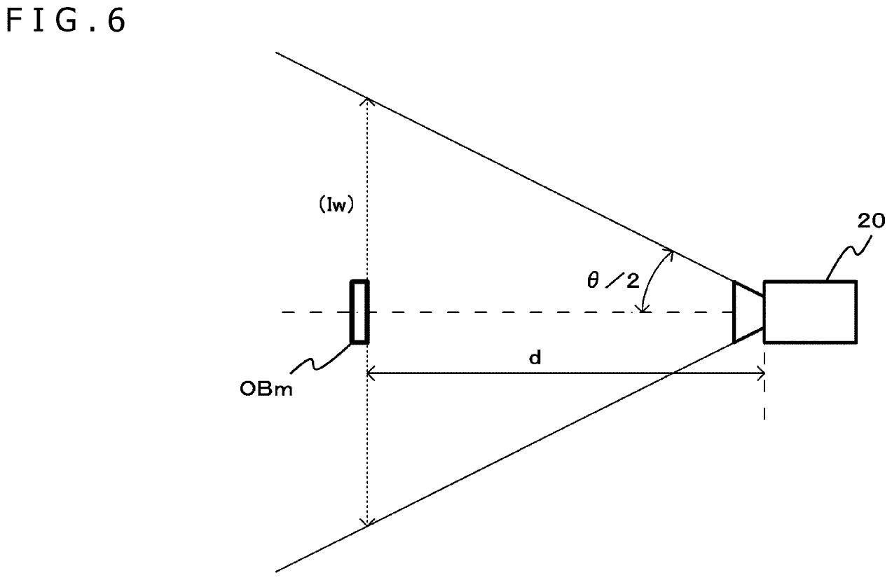

FIG. 6 is a diagram for explaining an operation of the moving-speed detecting section. It is assumed that the horizontal view angle of the imaging sections 21g and 21r of the imaging device 20 is an angle θ and the horizontal direction is the number Iw of pixels. Further, the distance between the imaging device 20 and a detection target OBm is a distance d. In this case, in the position of the detection target OBm, a horizontal distance Xp corresponding to one pixel interval in the horizontal direction can be calculated on the basis of Expression (1).

$$\begin{matrix}[ Math . 1 ] & \\ {x}_{p} = \frac{( 2 d tan θ / 2 )}{{I}_{w}} & ( 1 )\end{matrix}$$

Here, it is assumed that the difference in exposure timing from the reference line Lb reading of which is posterior to reading of the base line La is a time period Ts. The moving speed Vob of the detection target can be calculated on the basis of Expression (2) using the base deviation amount EPa, the position deviation amount EPb, the distance Xp, and the time period Ts.

$$\begin{matrix}[ Math . 2 ] & \\ {V}_{ob} = \frac{\{ EPb - EPa \} \times {x}_{p}}{Ts} & ( 2 )\end{matrix}$$

In such a way, the moving-speed detecting section 35 detects the moving speed of the detection target. Then, the flow proceeds to step ST10.

In step ST10, the image processing device determines whether line reading in the process target region is completed. In a case where reading of a line in the process target region is to be performed by a new line reading process, the distortion calculating section 33 of the image processing device 30 determines that line reading in the process target region is not completed. Then, the flow proceeds to step ST11. In addition, in a case where, if a new line reading process is performed, line reading in a region different from the process target region will be performed, the distortion calculating section 33 determines that line reading in the process target region is completed. Then, the flow is ended.

In step ST11, the image processing device performs a base updating process. The distortion calculating section 33 of the image processing device 30 specifies, as a new first position, the second position subjected to the image reading in step ST7, and specifies the reference line Lb as a new base line La. In addition, the position deviation amount EPb calculated on the basis of the image of the reference line Lb is specified as a base deviation amount EPa. Then, the flow returns to step ST7.

As a result of the abovementioned processes, the image processing device can frequently detect the moving speed Vob of the detection target at a resolution corresponding to the line interval (time difference) between the first position and the second position.

It is to be noted that the flowchart illustrated in FIG. 5 is an example, and thus, a process different from those in FIG. 5 may be performed. For example, an object recognition process using the non-distortion image obtained in step ST4 may be performed. Also, step ST7 is not limited to reading of a line directly under a base line in a case where a shift of a readout line is made downwardly, and the line interval between the first position and the second position may be widened. When the line interval between the first position and the second position is widened, the resolution of detecting a moving speed is lowered, compared to the case where a line directly under a base line is read out. However, a time period required to complete the moving speed detection can be shortened.

In addition, the interval between lines to be read out may be adjusted according to the image size, in the vertical direction, of the detection target detected as a result of the object recognition process in step ST2. That is, in a case where the image size is small, the line interval between the first position and the second position is set to be small, and further, the frequency of detecting moving speeds is set to be high. In a case where the image size is large, the line interval is set to be wide, so that a time period required to complete the moving speed detection is shortened. Accordingly, the moving speed of the detection target can be efficiently detected.

Moreover, the amount of the position deviation between line images of the subject in an identical position in the distortion image and the non-distortion image may be specified as the distortion amount to calculate the moving speed. Specifically, the amount of the position deviation between line images at the second position with respect to the base deviation amount EPa in the first position calculated as a result of execution of step ST5 and step ST6 is specified as the distortion amount to calculate the moving speed. In addition, while the first position is fixed, only the second position is sequentially updated in the readout direction, so that the moving speed is detected. When the moving speed is detected in such a manner, the detection result of the moving speed can quickly be obtained, and the line interval (time difference) between the first position and the second position, that is, the time period Ts that is taken to calculate the moving speed, becomes longer each time the second position is updated. Accordingly, a stable detection result can be obtained.

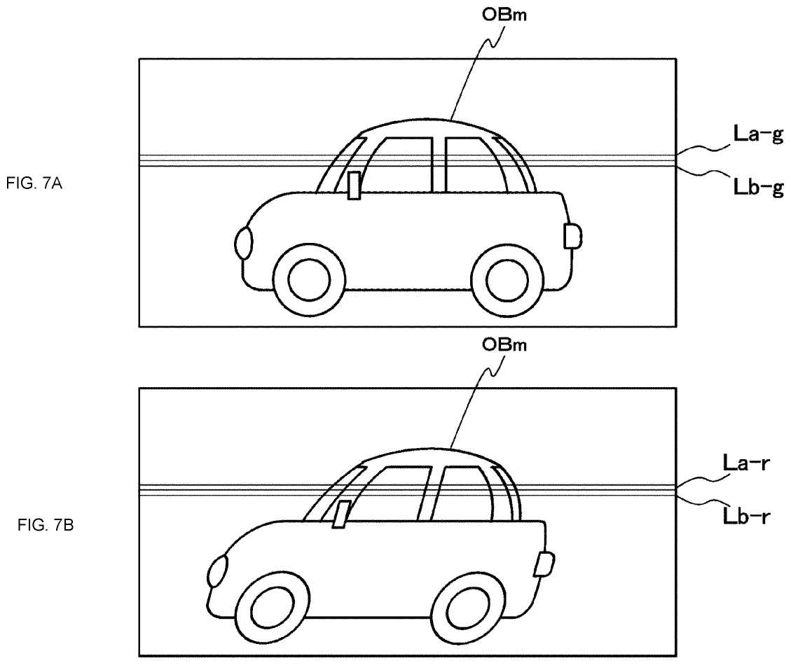

FIG. 7 is a diagram illustrating the first operation. In FIG. 7, (a) illustrates a non-distortion image acquired by the imaging section 21g. In FIG. 7, (b) illustrates a distortion image acquired by the imaging section 21r. The distortion calculating section 33 reads out a pixel signal of the base line La from each of the non-distortion image and the distortion image. It is to be noted that the base line La in the non-distortion image and the base line La in the distortion image are defined as a signal SLa-g and a signal SLa-r, respectively. In addition, the distortion calculating section 33 reads out a pixel signal of the reference line Lb from each of the non-distortion image and the distortion image. It is to be noted that the base line Lb in the non-distortion image and the base line Lb in the distortion image are defined as a signal SLb-g and a signal SLb-r, respectively.

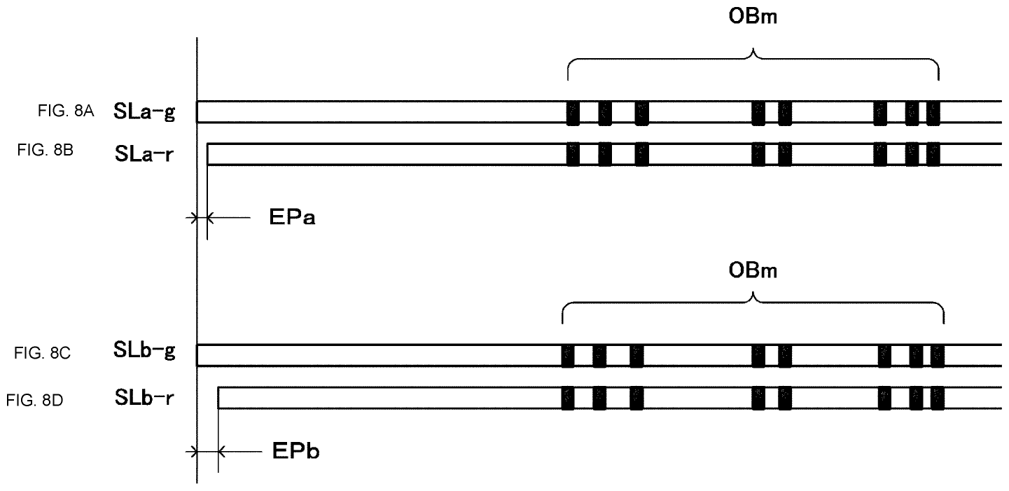

FIG. 8 illustrates signals of a base line and a reference line. In FIG. 8, (a) illustrates the signal SLa-g of the base line La. In FIG. 8, (b) illustrates the signal SLa-r of the base line La in a distortion image. In FIG. 8, (c) illustrates the signal SLb-g of the reference line Lb in a non-distortion image. In FIG. 8, (d) illustrates the signal SLb-r of the reference line Lb in the distortion image.

Regarding the base line La, the distortion calculating section 33 calculates the base deviation amount EPa between the non-distortion image and the distortion image. Specifically, an image of the base line La in the distortion image is shifted by unit of pixel, and a shift amount by which the difference regarding the region of the detection target OBm becomes minimum is defined as the base deviation amount EPa.

Further, regarding the reference line Lb, the distortion calculating section 33 calculates the position deviation amount EPb between the non-distortion image and the distortion image. Specifically, an image of the reference line Lb in the distortion image is shifted by unit of pixel, and a shift amount by which the difference regarding the region of the detection target OBm becomes minimum is defined as the position deviation amount EPb. Further, when the time difference in exposure timing between the base line La and the reference line Lb is defined as the time period Ts, a moving speed Vob of the detection target OBm between the base line and the reference line can be calculated on the basis of Expression (2).

In addition, since the reference line Lb is updated to be a base line for the next moving speed detection, the moving speed of the detection target OBm can be calculated at the line-based time interval.

Incidentally, in the first operation illustrated in FIG. 7, the number of the moving object is illustrated to be one. However, also in a case where plural moving objects are included in the image capturing range, the moving speed of each of the moving objects can be calculated by the abovementioned processes. In addition, when the line readout order is controlled, the difference between timings at which the detection results of moving speeds of the plural moving objects are obtained can be reduced.

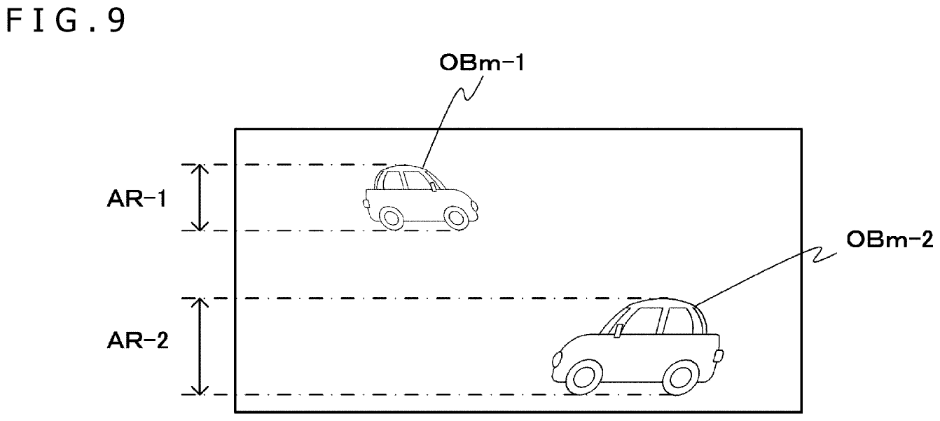

FIG. 9 illustrates an operation in a case where plural moving objects are included. For example, two detection targets OBm-1 and OBm-2 are included in a captured image. The distortion calculating section 33 divides the captured image into a region AR-1 including the detection target OBm-1 and a region AR-2 including the detection target OBm-2, on the basis of a recognition result obtained by the object recognizing section 32. Further, the distortion calculating section 33 calculates the moving speed in one line, for example, in the region AR-1, and then, conducts moving speed calculation in the region AR-2. The distortion calculating section 33 calculates the moving speed in the next line in the region AR-1, after calculating the moving speed in one line, for example, in the region AR-2. While the divided regions are alternately selected, the moving speeds are calculated in such a manner. As a result, the calculation results of the moving speeds of the detection targets OBm-1 and OBm-2 can be obtained more quickly, compared to a case where the captured image is not divided into regions. That is, in a case where the captured image is not divided into regions, the moving speed of the detection target OBm-2 is not detected until detection of the moving speed of the detection target OBm-1 is completed. However, when the moving speeds are sequentially detected in each of the regions, the moving speed of the detection target OBm-2 can be detected before detection of the moving speed of the detection target OBm-1 is completed. It is to be noted that, since the moving speeds are sequentially detected in each of the regions, a time period from the first detection of a moving speed to the last detection of a moving speed becomes longer.

As a result of the first operation, the image processing device can quickly and frequently detect the moving speed of a subject that is moving.

In addition, the imaging device 20 is illustrated to be fixed in the above embodiment. However, the imaging device 20 may move. In this case, in a distortion image obtained by the imaging section 21r, a still object, for example, is distorted according to movement of the imaging device 20. That is, from the distortion of the still object, the moving speed of the imaging device 20 can be calculated. Furthermore, since the moving speed of the imaging device 20 can be detected, the detected moving speed may be used for self-position estimation.

In the conventional self-position estimation, a self-position is estimated with use of the rotational amount of a wheel, positioning satellite information, or the like. However, a self-position cannot be detected with high precision under a situation where an error is caused by idling of wheels or the sensitivity of receiving a positioning signal is poor, for example. However, with the present technology, a moving speed can be detected on the basis of captured images. Thus, when the detected moving speed is used to determine the movement amount, a self-position can be estimated with high precision even in a situation where wheels are idling or the sensitivity of receiving a positioning signal is poor.

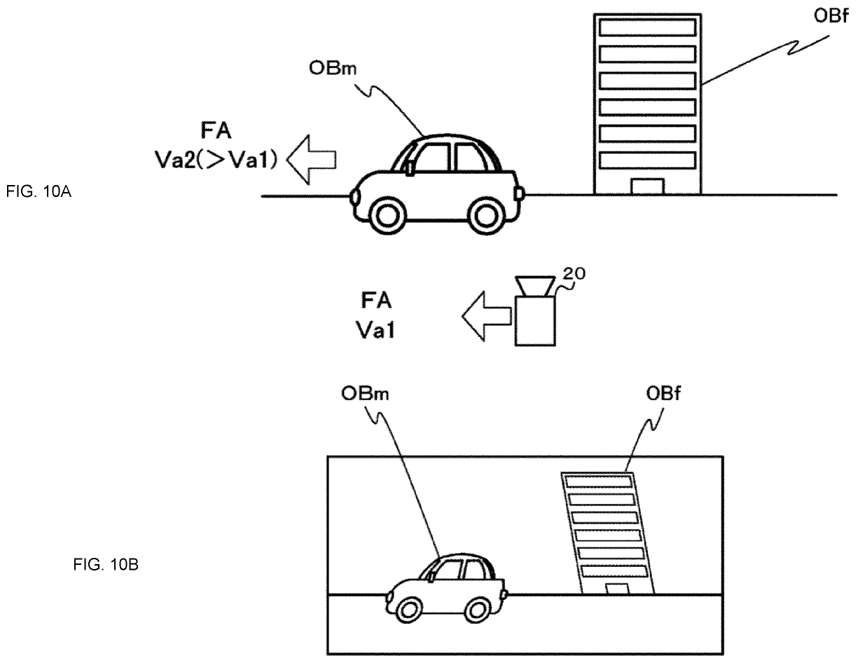

FIG. 10 illustrates a case in which an imaging device is mounted on a side surface of a mobile body. In FIG. 10, (a) illustrates the relation between the imaging device 20 and a subject. The imaging device 20 captures an image of a detection target (e.g., a building) OBf and an image of a detection target (e.g., a car) OBm. The mobile body (own vehicle) having the imaging device 20 mounted thereon is moving in the direction of an arrow FA at the moving speed Va1, while the detection target OBm is moving in the same direction as that of the own vehicle at the higher moving speed Va2 (>Va1).

In FIG. 10, (b) illustrates a distortion image obtained by the imaging device 20. A distortion of the detection target OBf is generated due to movement of the own vehicle. When a moving speed is calculated on the basis of the distortion of the detection target OBf, the moving speed Va1 of the own vehicle is detected. Accordingly, the detected moving speeds Va1 are integrated to determine the movement amount of the own vehicle, so that the position of the own vehicle can be estimated. In addition, a distortion of the detection target OBm is generated according to a moving speed (Va2−Va1) relative to the own vehicle. When a moving speed is calculated on the basis of this distortion, the relative moving speed of the detection target OBm can be detected. Moreover, even in a case where the imaging device 20 is moving, the moving speed Va2 of the detection target OBm can be detected on the basis of the moving speed of the own vehicle and the relative moving speed of the detection target OBm.

<3-2. Second Operation>

Next, a second operation in the embodiment will be explained. In the second operation, a geometric transformation (e.g., an affine transformation) is performed on an image of a process target region in a base image, a distortion amount is calculated on the basis of a geometric transformation that results in the minimum difference between the base image (geometrically transformed image) having undergone the geometric transformation and the distortion image, and the moving speed of the detection target is detected in each line on the basis of the distortion amount.

FIG. 11 illustrates a flowchart of the second operation. In step ST21, the imaging device performs image capturing in a global shutter mode. The imaging device 20 performs image capturing by means of the imaging section 21g of a global shutter mode, and obtains a captured image. Then, the flow proceeds to step ST22.

In step ST22, the image processing device performs an object recognition process. The object recognizing section 32 of the image processing device 30 recognizes objects included in the captured image obtained in step ST21, and detects a detection target the moving speed of which is to be detected. Then, the flow proceeds to step ST23.

In step ST23, the image processing device performs a distance measuring process. The distance measuring section 34 of the image processing device 30 measures the distance to the detection target detected in step ST22. Then, the flow proceeds to step ST24.

In step ST24, the imaging device performs image capturing in both modes. The imaging device 20 performs image capturing by means of both the imaging section 21g of the global shutter mode and the imaging section 21r of the rolling shutter mode, and obtains a non-distortion image and a distortion image. Then, the flow proceeds to step ST25.

In step ST25, the image processing device performs a process of extracting an image from a base image. The distortion calculating section 33 of the image processing device 30 extracts, from a base image, an image of a process target region, that is, an image of a region indicating the detection target detected in step ST22. Then, the flow proceeds to step ST26.

In step ST26, the image processing device performs a geometric transformation process on the extracted image. The distortion calculating section 33 generates a geometrically transformed image by performing the geometric transformation process on the extracted image obtained as a result of the image extracting process in step ST25 such that a distortion according to movement of the detection target is generated. Then, the flow proceeds to step ST27.

In step ST27, the image processing device determines whether the difference between the distortion image and the geometrically transformed image is equal to or less than a threshold. In a case where the distortion calculating section 33 of the image processing device 30 determines that the difference between the geometrically transformed image generated in step ST26 and the distortion image is equal to or less than the threshold, that is, the distortion of an image of the detection target in the base image is equivalent to the distortion of an image of the detection target in the distortion image, the flow proceeds to step ST29. In a case where the difference is greater than the threshold, the flow proceeds to step ST28.

In step ST28, the image processing device updates a transformation matrix. The distortion calculating section 33 of the image processing device 30 updates the transformation matrix for a geometric transformation process because the distortion of the extracted image has not been corrected to be equal to or less than the threshold. Then, the flow returns to step ST26 to perform a geometric transformation process on the extracted image.

In step ST29, the image processing device performs a distortion amount determination process. After determining that the difference between the distortion image and the geometrically transformed image is equal to or less than the threshold in step ST27, the distortion calculating section 33 determines the distortion amount in the distortion image on the basis of the geometric transformation performed in step ST26. It is to be noted that, as the distortion amount, the amount of the position deviation between, for example, the uppermost line and the lowermost line in the extracted image may be determined, or the amount of the position deviation between lines in the extracted image may be calculated. The distortion calculating section 33 determines a subject image distortion generated in the distortion image. Then, the flow proceeds to step ST30.

In step ST30, the image processing device performs a moving speed detection process. The moving-speed detecting section 35 of the image processing device 30 detects the moving speed of the detection target on the basis of the distance d to the detection target measured in step ST22, the distortion amount determined in step ST29, and information regarding predefined image capturing conditions (e.g., view angles and resolutions) of the imaging sections 21g and 21r.

In the abovementioned manner, the image processing device may perform a geometric transformation process on an image of a detection target in a base image, determine a distortion amount according to movement of the detection target on the basis of the geometrically transformed image and a distortion image, and detect the moving speed of the detection target.

<3-3. Other Operations>

In the abovementioned first and second operations, a subject is moving so as to cross an area ahead of the imaging device 20. However, the present technology may be applied to a case where a subject is moving in a direction approaching the imaging device 20 or a direction separating from the imaging device 20.

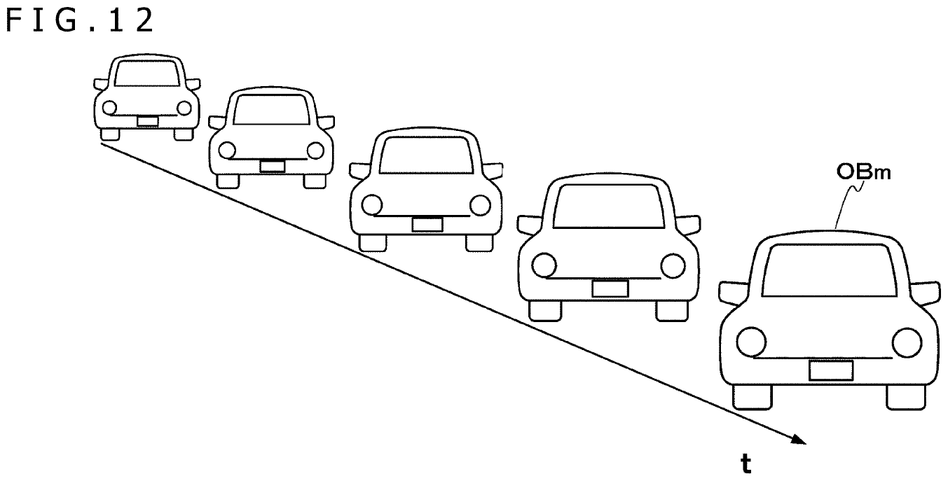

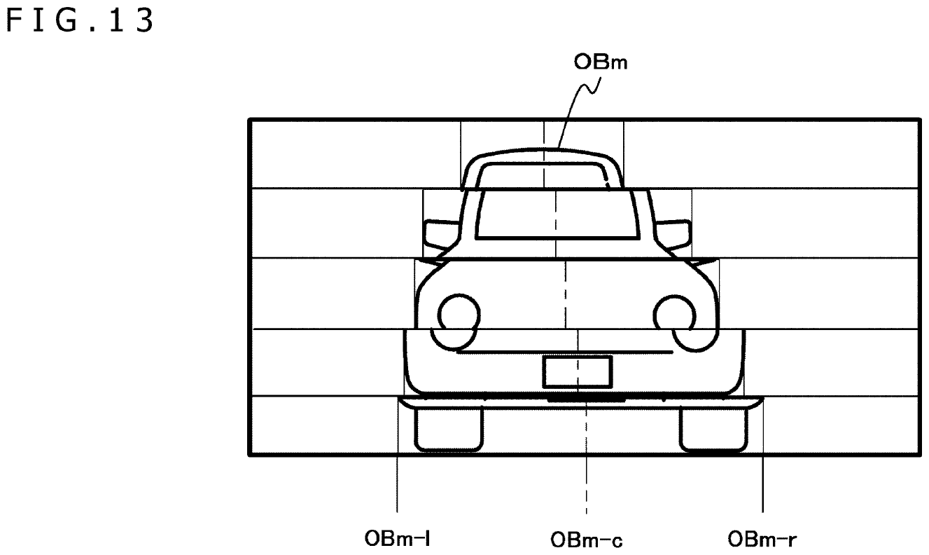

FIG. 12 illustrates a case where a subject is approaching an imaging device. FIG. 13 is a diagram for explaining calculation of a moving speed. It is to be noted that FIG. 13 uses a captured image vertically divided into five regions for simplification of explanation, but, in practice, a captured image is divided by units of lines in a time-series manner.

In a case where the detection target OBm is approaching, as illustrated in FIG. 12, a scale change occurs in each divided region, as illustrated in FIG. 13. Here, the distortion calculating section 33 of the image processing device obtains a left edge OBm-1, a right edge OBm-r, and a center position OBm-c of the detection target OBm from each of the divided regions. In addition, the distortion calculating section 33 calculates the moving speed in the left-right direction from the position deviation amount, in the left-right direction, of the center position OBm-c, as in the explanation given above for the case where a subject is moving in the horizontal direction. It is to be noted that the distance to the detection target OBm is measured by the distance measuring section 34 when the captured image is obtained. In addition, the moving speed in the separating and approaching direction can be obtained from the measurement result of the distance to the detection target OBm.

Thus, according to the present technology, the moving speed in the separating and approaching direction can be detected on the basis of a distance measurement result obtained by the distance measuring section 34, and further, the moving speed in a direction orthogonal to the separating and approaching direction can be detected quickly and frequently on the basis of captured images. Consequently, while not only the moving speed in the separating and approaching direction but also the moving speed in the direction orthogonal to the separating and approaching direction is taken into consideration, an action for avoiding a collision with the detection target OBm, for example, can be conducted with high precision.

### 4. APPLICATION EXAMPLES

A technology according to the present disclosure is applicable to a variety of products. For example, a technology according to the present disclosure can be implemented as a device that is mounted on any one of automobiles, electric automobiles, hybrid electric automobiles, motorcycles, bicycles, personal mobilities, aircrafts, drones, ships, robots, construction machines, agricultural machines (tractors), etc.

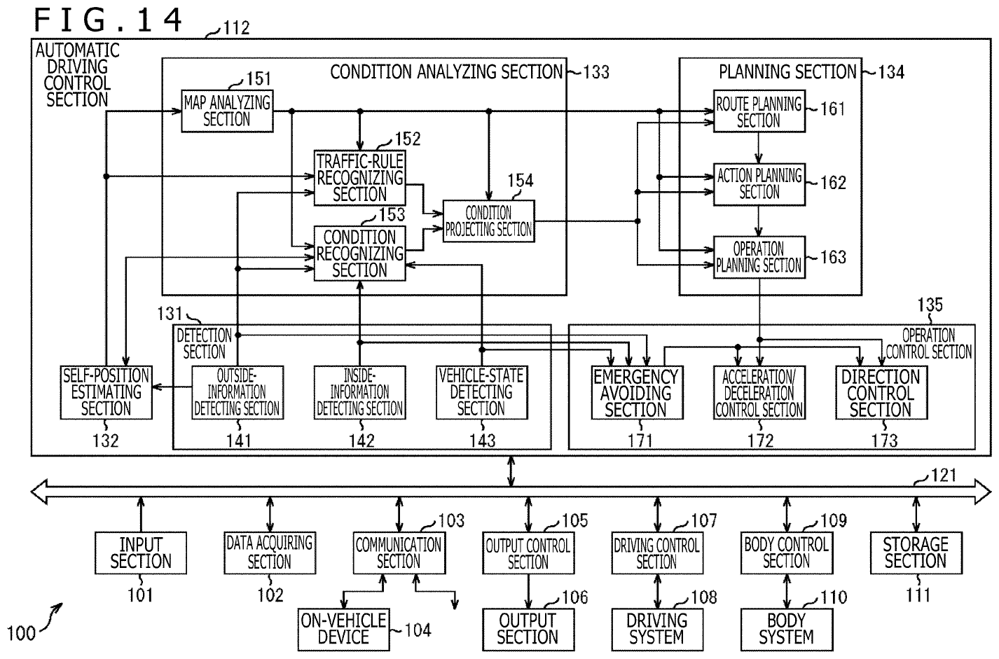

FIG. 14 is a block diagram illustrating a schematic functional configuration example of a vehicle control system 100 that is one example of a moving-body control system to which the present technology is applicable.

It is to be noted that, hereinafter, a vehicle having the vehicle control system 100 installed therein is referred to as an own vehicle in order to distinguish the vehicle from any other vehicles.

The vehicle control system 100 includes an input section 101, a data acquiring section 102, a communication section 103, an on-vehicle device 104, an output control section 105, an output section 106, a driving control section 107, a driving system 108, a body control section 109, a body system 110, a storage section 111, and an automatic driving control section 112. The input section 101, the data acquiring section 102, the communication section 103, the output control section 105, the driving control section 107, the body control section 109, the storage section 111, and the automatic driving control section 112 are connected to one another over a communication network 121. The communication network 121 includes a bus or an on-vehicle communication network conforming to any standard. The on-vehicle communication network is a CAN (Controller Area Network), a LIN (Local Interconnect Network), a LAN (Local Area Network), FlexRay (registered trademark), or the like. It is to be noted that the sections in the vehicle control system 100 may sometimes be directly connected without the communication network 121.

It is to be noted that, hereinafter, a description regarding the communication network 121 will be omitted in a case where communication between the sections in the vehicle control system 100 is performed over the communication network 121. For example, communication between the input section 101 and the automatic driving control section 112 over the communication network 121 will simply be expressed as communication between the input section 101 and the automatic driving control section 112.

The input section 101 includes a device that an occupant uses to input various kinds of data and instructions, etc. For example, the input section 101 includes an operation device such as a touch panel, a button, a microphone, a switch, or a lever and an operation device through which input can be performed by voice or a gesture rather than a manual operation. In addition, for example, the input section 101 may be a remote controller using infrared rays or any other radio waves, or an external connection device such as a mobile or wearable device capable of handling an operation of the vehicle control system 100. The input section 101 generates an input signal on the basis of data or an instruction inputted by an occupant, and supplies the input signal to sections in the vehicle control system 100.

The data acquiring section 102 includes various sensors that acquire data for use in processes in the vehicle control system 100, and supplies the acquired data to sections in the vehicle control system 100.

For example, the data acquiring section 102 includes various sensors for detecting the state of the own vehicle. Specifically, the data acquiring section 102 includes a gyrosensor, an acceleration sensor, an inertial measurement unit (IMU), and a sensor for detecting the operation amount of an acceleration pedal, the operation amount of a brake pedal, the steering angle of a steering wheel, an engine rotation speed, a motor rotation speed, or the rotational speed of wheels, etc., for example.

In addition, for example, the data acquiring section 102 includes various sensors for detecting information regarding the outside of the own vehicle. Specifically, the data acquiring section 102 includes an imaging device such as a ToF (Time Of Flight) camera, a stereo camera, a single lens camera, an infrared camera, or any other camera, for example. Moreover, for example, the data acquiring section 102 includes an environment sensor for detecting weather, etc., and a surroundings information detection sensor for detecting objects in the surroundings of the own vehicle. The environment sensor includes a raindrop sensor, a fog sensor, a sunshine sensor, or a snow sensor, for example. The surroundings information detection sensor includes an ultrasonic sensor, a radar, a LiDAR (Light Detection and Ranging, Laser Imaging Detection and Ranging), or a sonar, for example.

In addition, for example, the data acquiring section 102 includes various sensors for detecting the current position of the own vehicle. Specifically, the data acquiring section 102 includes a GNSS (Global Navigation Satellite System) receiver that receives a GNSS signal from a GNSS satellite, for example.

In addition, for example, the data acquiring section 102 includes various sensors for detecting information regarding the interior of the own vehicle. Specifically, the data acquiring section 102 includes an imaging device that captures an image of a driver, a biological sensor that detects biological information regarding the driver, and a microphone that collects sounds in the interior of the vehicle, for example. The biological sensor is provided on a seat surface or a steering wheel, for example, and detects biological information regarding an occupant who is sitting on the seat or a driver who is holding the steering wheel.

The communication section 103 performs communication with the on-vehicle device 104, various apparatuses external to the own vehicle, a server, a base station, etc., and thereby transmits data supplied from sections in the vehicle control system 100 or supplies received data to the sections in the vehicle control system 100. It is to be noted that a communication protocol that is supported by the communication section 103 is not limited to any particular type, and moreover, the communication section 103 may support plural types of communication protocols.

For example, the communication section 103 performs wireless communication with the on-vehicle device 104 through a wireless LAN, Bluetooth (registered trademark), NFC (Near Field Communication), a WUSB (Wireless USB), or the like. In addition, for example, the communication section 103 performs wired communication with the on-vehicle device 104 through a USB (Universal Serial Bus), an HDMI (registered trademark) (High-Definition Multimedia Interface), an MHL (Mobile High-definition Link), or the like via an unillustrated connection terminal (and a cable, if needed).

Moreover, for example, the communication section 103 performs communication with an apparatus (e.g., an application server or a control server) present on an external network (e.g., the internet, a cloud network, or a network unique to a company) via a base station or an access point. In addition, for example, by using a P2P (Peer To Peer) technology, the communication section 103 performs communication with a terminal (e.g., a pedestrian terminal, a shop terminal, or an MTC (Machine Type Communication) terminal) that is located near the own vehicle. In addition, for example, the communication section 103 performs V2X communication such as vehicle-to-vehicle communication, vehicle-to-infrastructure communication, vehicle-to-home communication, or vehicle-to-pedestrian communication. Further, for example, the communication section 103 includes a beacon receiving section to receive radio waves or electromagnetic waves emitted from a wireless station or the like installed on a road, so that information regarding the current position, a traffic jam, a traffic regulation, or a required time period is obtained.

The on-vehicle device 104 includes a mobile or wearable device that is carried by an occupant, an information device that is installed or mounted on the own vehicle, and a navigation device that searches for a route to any destination, for example.

The output control section 105 controls outputs of various kinds of information to an occupant in the own vehicle or to the outside of the own vehicle. For example, the output control section 105 generates an output signal including any one of visual information (e.g., image data) and/or auditory information (e.g., sound data), and supplies the output signal to the output section 106. As a result, the output control section 105 controls output of visual information and output of auditory information from the output section 106. Specifically, the output control section 105 generates a bird's eye view image or a panorama image by combining pieces of data of images captured by different imaging devices of the data acquiring section 102, for example, and supplies an output signal including the generated image to the output section 106. Further, for example, the output control section 105 generates sound data including an alarm sound, an alarm message, or the like, with regard to such dangers as a collision, contact, and entry into a dangerous area, and supplies an output signal including the generated sound data to the output section 106.

The output section 106 includes a device capable of outputting visual information or auditory information to an occupant in the own vehicle or the outside of the own vehicle. For example, the output section 106 includes a display device, an instrument panel, an audio speaker, a headphone, a wearable device such as a spectacle type display to be worn by an occupant, a projector, or a lamp. The output section 106 may include, other than a device having a normal display, a device that displays visual information within the visual field of a driver. Examples of such a device include a head-up display, a transmission type display, and a device having an AR (Augmented Reality) display function.

The driving control section 107 generates various control signals, and supplies the signals to the driving system 108 to thereby control the driving system 108. In addition, the driving control section 107 supplies a control signal to some sections excluding the driving system 108, if needed, and thereby gives a notification regarding the controlled state of the driving system 108.

The driving system 108 includes various devices related to driving of the own vehicle. For example, the driving system 108 includes a driving-force generating device for generating a force to drive an internal combustion engine or a drive motor, a driving-force transmission mechanism for transmitting the driving force to a wheel, a steering mechanism for controlling the steering angle, a braking device for generating a braking force, an ABS (Antilock Brake System), an ESC (Electronic Stability Control), an electric power steering device, etc.

The body control section 109 generates various control signals, supplies the control signals to the body system 110, and thereby controls the body system 110. Further, the body control section 109 supplies a control signal to some sections excluding the body system 110, if needed, and thereby gives a notification regarding the controlled state of the body system 110.

The body system 110 includes various body-related devices mounted on the vehicle body. For example, the body system 110 includes a keyless entry system, a smart key system, a power window device, a power seat, a steering wheel, an air conditioner, lamps (e.g., headlamps, back lamps, brake lamps, blinkers, fog lamps, etc.), etc.

The storage section 111 includes a magnetic storage device such as a ROM (Read Only Memory), a RAM (Random Access Memory), or an HDD (Hard Disc Drive), a semiconductor storage device, an optical storage device, or a magneto-optical storage device, for example. The storage section 111 stores, for example, a variety of programs and data for use in the sections in the vehicle control system 100. For example, the storage section 111 stores map data regarding a high-precision 3D map such as a dynamic map, a global map which has lower precision but covers a wider area than the high-precision map, and a local map including information regarding the surroundings of the own vehicle, etc.

The automatic driving control section 112 performs control for automatic driving such as autonomous traveling or driving support. Specifically, the automatic driving control section 112 performs cooperative control for implementing ADAS (Advanced Driver Assistance System) functions of avoiding a collision of the own vehicle or absorbing shock, performing following traveling based on a vehicle-to-vehicle distance, traveling at fixed vehicle speed, and issuing an alarm regarding a collision of the own vehicle or regarding lane departure of the own vehicle, for example. In addition, for example, the automatic driving control section 112 performs cooperative control for automatic driving such that the own vehicle autonomously travels without depending on a driver's operation. The automatic driving control section 112 includes a detection section 131, a self-position estimating section 132, a condition analyzing section 133, a planning section 134, and an operation control section 135.

The detection section 131 detects various types of information necessary for automatic driving control. The detection section 131 includes an outside-information detecting section 141, an inside-information detecting section 142, and a vehicle-state detecting section 143.

The outside-information detecting section 141 performs a process of detecting information regarding the outside of the own vehicle on the basis of data or signals supplied from sections in the vehicle control system 100. For example, the outside-information detecting section 141 detects, recognizes, and tracks an object in the surroundings of the own vehicle and detects the distance to the object. Examples of the object to be detected include a vehicle, a person, an obstacle, a structure, a road, a traffic signal, a traffic sign, and a road sign. Further, for example, the outside-information detecting section 141 performs a process of detecting a surrounding environment of the own vehicle. Examples of the surrounding environment to be detected include weather, temperature, humidity, brightness, and a road condition. The outside-information detecting section 141 supplies data indicating the detection result to the self-position estimating section 132, a map analyzing section 151, a traffic-rule recognizing section 152, and a condition recognizing section 153 of the condition analyzing section 133, and an emergency avoiding section 171 of the operation control section 135, etc.

The inside-information detecting section 142 performs a process of detecting information regarding the interior of the own vehicle on the basis of data or signals from sections in the vehicle control system 100. For example, the inside-information detecting section 142 authenticates and recognizes a driver, detects the state of the driver, detects an occupant, and detects the vehicle interior environment. Examples of the state of the driver to be detected include the health condition, the awakening degree, the concentration degree, the fatigue degree, and the direction of the visual line. Examples of the vehicle interior environment to be detected include temperature, humidity, brightness, and a smell. The inside-information detecting section 142 supplies data indicating the detection result to the condition recognizing section 153 of the condition analyzing section 133 and the emergency avoiding section 171 of the operation control section 135, etc.

The vehicle-state detecting section 143 performs a process of detecting the state of the own vehicle on the basis of data or signals from sections in the vehicle control system 100. Examples of the state of the own vehicle to be detected include the speed, the acceleration, the steering angle, the presence/absence of an abnormality, the driving operation state, the position and inclination of a power seat, a door lock state, and the states of any other on-vehicle devices. The vehicle-state detecting section 143 supplies data indicating the detection process result to the condition recognizing section 153 of the condition analyzing section 133 and the emergency avoiding section 171 of the operation control section 135, etc.

The self-position estimating section 132 performs a process of estimating the position and the posture of the own vehicle on the basis of data or signals supplied from sections in the vehicle control system 100 such as the outside-information detecting section 141 and the condition recognizing section 153 of the condition analyzing section 133. In addition, the self-position estimating section 132 generates, if needed, a local map (hereinafter, referred to as a self-position estimation map) for use in estimating the position of the own vehicle. For example, a high-precision map using a technology such as SLAM (Simultaneous Localization and Mapping) is used as the self-position estimation map. The self-position estimating section 132 supplies data indicating the estimation process result to the map analyzing section 151, the traffic-rule recognizing section 152, and the condition recognizing section 153 of the condition analyzing section 133, etc. Also, the self-position estimating section 132 stores the self-position estimation map in the storage section 111.

The condition analyzing section 133 performs a process of analyzing the condition of the own vehicle and the surrounding condition. The condition analyzing section 133 includes the map analyzing section 151, the traffic-rule recognizing section 152, the condition recognizing section 153, and a condition projecting section 154.

By using, if needed, data or signals supplied from sections in the vehicle control system 100 such as the self-position estimating section 132 and the outside-information detecting section 141, the map analyzing section 151 performs a process of analyzing various maps stored in the storage section 111, and constructs a map that includes information necessary for an automatic driving process. The map analyzing section 151 supplies the constructed map to the traffic-rule recognizing section 152, the condition recognizing section 153, the condition projecting section 154, and a route planning section 161, an action planning section 162, and an operation planning section 163 of the planning section 134, etc.

The traffic-rule recognizing section 152 performs a process of recognizing a traffic rule in the surroundings of the own vehicle on the basis of data or signals supplied from sections in the vehicle control system 100 such as the self-position estimating section 132, the outside-information detecting section 141, and the map analyzing section 151. As a result of this recognizing process, the position and the state of a traffic signal in the surroundings of the own vehicle, the details of a traffic regulation imposed in the surroundings of the own vehicle, and a lane on which the vehicle can travel are recognized, for example. The traffic-rule recognizing section 152 supplies data indicating the recognition process result to the condition projecting section 154, etc.

The condition recognizing section 153 performs a process of recognizing a condition related to the own vehicle on the basis of data or signals supplied from sections in the vehicle control system 100 such as the self-position estimating section 132, the outside-information detecting section 141, the inside-information detecting section 142, the vehicle-state detecting section 143, and the map analyzing section 151. For example, the condition recognizing section 153 recognizes a condition of the own vehicle, a condition of the surroundings of the own vehicle, and a condition of a driver of the own vehicle. In addition, the condition recognizing section 153 generates, if needed, a local map (hereinafter, referred to as a map for condition recognition) for use in recognition of a condition of the surroundings of the own vehicle. For example, an occupancy grid map is used as the map for condition recognition.

Examples of the condition of the own vehicle to be recognized include the position, the posture, and motion (e.g., the speed, the acceleration, and the movement direction) of the vehicle, the presence/absence of an abnormality, and details of the abnormality. Examples of the condition of the surroundings of the own vehicle to be recognized include the type and position of a still object in the surroundings, the type, the position, and the motion (e.g., the speed, the acceleration, and the movement direction) of a moving body in the surroundings, the structure of a road in the surroundings, the state of the road surface, and weather, temperature, humidity, and brightness in the surroundings. Examples of the condition of the driver to be recognized include the health condition, the awakening degree, the concentration degree, the fatigue degree, the direction of a visual line, and a driving operation.

The condition recognizing section 153 supplies data (including the map for condition recognition, if needed) indicating the recognition process result to the self-position estimating section 132, the condition projecting section 154, etc. In addition, the condition recognizing section 153 stores the map for condition recognition into the storage section 111.

The condition projecting section 154 performs a process of projecting conditions regarding the own vehicle on the basis of data or signals supplied from sections in the vehicle control system 100 such as the map analyzing section 151, the traffic-rule recognizing section 152, and the condition recognizing section 153. For example, the condition projecting section 154 performs a process of projecting a condition of the own vehicle, a condition in the surroundings of the own vehicle, a condition of the driver, etc.

Examples of the condition of the own vehicle to be projected include a behavior of the vehicle, occurrence of an abnormality in the own vehicle, and the travelable distance of the own vehicle. Examples of the condition in the surroundings of the own vehicle to be projected include a behavior of a moving object in the surroundings of the own vehicle, a state change of a traffic signal, and a change in the environment such as weather. Examples of the condition of the driver to be projected include a behavior of the driver and the health condition of the driver.

Data indicating the projection process result and data supplied from the traffic-rule recognizing section 152 and the condition recognizing section 153 are supplied from the condition projecting section 154 to the route planning section 161, the action planning section 162, and the operation planning section 163 of the planning section 134, etc.

The route planning section 161 plans a route to a destination on the basis of data or signals supplied from sections in the vehicle control system 100 such as the map analyzing section 151 and the condition projecting section 154. For example, the route planning section 161 defines a route from the current position to a designated destination on the basis of a global map. In addition, for example, the route planning section 161 changes the route, as appropriate, on the basis of a traffic jam, an accident, a traffic regulation, a construction state, the health condition of the driver, etc. The route planning section 161 supplies data indicating the planned route to the action planning section 162, etc.

The action planning section 162 plans an action of the own vehicle for carrying out safe traveling on the route planned by the route planning section 161, within a planned time period, on the basis of data or signals supplied from sections in the vehicle control system 100 such as the map analyzing section 151 and the condition projecting section 154. For example, the action planning section 162 plans a start/stop, a traveling direction (e.g., forward traveling, rearward traveling, a left turn, a right turn, and a direction change), a travel lane, a travel speed, and passing other vehicles. The action planning section 162 supplies data indicating the planned action of the own vehicle to the operation planning section 163, etc.

The operation planning section 163 plans an operation of the own vehicle for implementing the action planned by the action planning section 162, on the basis of data or signals supplied from sections in the vehicle control system 100 such as the map analyzing section 151 and the condition projecting section 154. For example, the operation planning section 163 plans an acceleration, a deceleration, and a traveling trajectory, etc. The operation planning section 163 supplies data indicating the planned operation of the own vehicle to an acceleration/deceleration control section 172 and a direction control section 173 of the operation control section 135, etc.

The operation control section 135 controls the operation of the own vehicle. The operation control section 135 includes the emergency avoiding section 171, the acceleration/deceleration control section 172, and the direction control section 173.

The emergency avoiding section 171 performs a process of detecting an emergency such as a collision, contact, entry into a dangerous area, an abnormality in the driver, and an abnormality in the vehicle, on the basis of the detection results obtained by the outside-information detecting section 141, the inside-information detecting section 142, and the vehicle-state detecting section 143. In a case of detecting occurrence of an emergency, the emergency avoiding section 171 plans an operation of the own vehicle to avoid the emergency. The operation is a sudden stop or a sudden turn, for example. The emergency avoiding section 171 supplies data indicating the planned operation of the own vehicle to the acceleration/deceleration control section 172 and the direction control section 173, etc.

The acceleration/deceleration control section 172 performs acceleration/decoration control to implement the operation of the own vehicle planned by the operation planning section 163 or the emergency avoiding section 171. For example, the acceleration/deceleration control section 172 calculates a control target value, of the driving-force generating device or the braking device, for implementing the planned acceleration, deceleration, or sudden stop, and supplies a control command indicating the calculated control target value to the driving control section 107.

The direction control section 173 performs direction control in order to implement the operation of the own vehicle planned by the operation planning section 163 or the emergency avoiding section 171. For example, the direction control section 173 calculates a control target value of the steering mechanism for implementing the traveling trajectory or the sudden turn planned by the operation planning section 163 or the emergency avoiding section 171, and supplies a control command indicating the calculated control target value to the driving control section 107.

In the moving-body control system having the above configuration, the imaging device 20 is provided in the data acquiring section 102, and the image processing device 30 according to the present technology is provided in the outside-information detecting section 141. Accordingly, a process of detecting the moving speed and the movement distance of an object in the surrounding of the own vehicle is performed. Since a detection result obtained by the image processing device 30 is supplied to the self-position estimating section 132, for example, the position of the own vehicle can be estimated with precision even in a case where wheels are idling or the sensitivity of receiving a positioning signal is poor. In addition, a detection result obtained by the image processing device 30 is supplied to the emergency avoiding section 171 of the operation control section 135. Accordingly, a process of detecting an emergency such as a collision or contact is performed.

For example, the emergency avoiding section 171 calculates a relative speed Vre of a surrounding object with respect to the own vehicle on the basis of the moving speed detected by the image processing device 30. Further, the emergency avoiding section 171 calculates a time Ttc (=Dre/Vre) left before a collision, on the basis of a distance Dre to the surrounding object measured by the distance measuring section, plans an operation of the own vehicle to avoid the emergency, and supplies the planned operation to the acceleration/deceleration control section 172 and the direction control section 173, etc.

Further, with the imaging device 20 provided on a side surface of the own vehicle, the relative moving speed of a vehicle that is traveling along with the own vehicle can be detected. Accordingly, the relative moving speed of a vehicle that is traveling along with the own vehicle can be used to determine a timing at which a lane change can be made safely.

Also, when the present technology is applied in the field of monitoring, movement of a subject included in a monitoring target range can be determined quickly and frequently.

A series of the processes explained herein can be executed by hardware, software, or a composite structure thereof. In a case where the processes are executed by software, a program having a sequence of the processes recorded therein can be executed after being installed into a memory of a computer incorporated in dedicated hardware, or can be executed after being installed into a general-purpose computer capable of executing various processes.

For example, the program can be preliminarily recorded in a hard disk, an SSD (Solid State Drive), or a ROM (Read Only Memory), which serves as a recording medium. Alternatively, the program can be temporarily or permanently stored (recorded) in a removable recording medium such as a flexible disk, a CD-ROM (Compact Disc Read Only Memory), an MO (Magneto optical) disk, a DVD (Digital Versatile Disc), a BD (Blu-Ray Disc (registered trademark)), a magnetic disk, or a semiconductor memory card. Such a removable recording medium can be provided in the form of what is generally called package software.

Further, the program may be installed from a removable recording medium to a computer, or may be transferred, by wire or by radio waves, from a download site to a computer over a network such as a LAN (Local Area Network) or the internet. The computer receives the program thus transferred, so that the program can be installed into a built-in recording medium such as a built-in hard disk or the like.

It is to be noted that the effects described in the present description are just examples, and thus, are not limitative. Another effect that is not described herein may be provided additionally. In addition, the present technology should not be interpreted from the above embodiment only. The present technology has been disclosed with use of the embodiment as an exemplification. It is obvious that a person skilled in the art can make modification or substitution on the embodiment within the gist of the present technology. That is, in order to assess the gist of the present technology, the claims should be considered.

In addition, the image processing device according to the present technology may also have the following configurations.

(1) An image processing device including:

a moving-speed detecting section that detects a moving speed of a subject on the basis of a subject image distortion generated in a first captured image obtained by exposure of lines at different timings.

(2) The image processing device according to (1), in which the moving-speed detecting section detects the moving speed of the subject on the basis of a view angle of the first captured image, a distance to the subject, and a distortion amount of the image distortion.

(3) The image processing device according to (2), in which

the moving-speed detecting section detects the moving speed of the subject in each line on the basis of the distortion amount of the image distortion in each line.

(4) The image processing device according to any one of (1) to (3), further including:

a distortion calculating section that calculates the subject image distortion, in which,

by using a second captured image obtained by exposure of lines at one timing, the distortion calculating section calculates the distortion amount.

(5) The image processing device according to (4), in which

the distortion calculating section calculates the distortion amount by using an amount of a position deviation between line images of the subject in an identical position in the first captured image and the second captured image.

(6) The image processing device according to (5), in which

the distortion calculating section uses, as the distortion amount, a difference between an amount of a position deviation between line images of the subject in a first position in the first captured image and the second captured image and an amount of a position deviation between line images of the subject in a second position at which the exposure timing is later than that at the first position, in the first captured image and the second captured image.

(7) The image processing device according to (7), in which

the distortion calculating section adjusts a line interval between the first position and the second position according to a size of a subject image.

(8) The image processing device according to (4), in which

the distortion calculating section calculates the distortion amount on the basis of a geometric transformation as a result of which a difference between the first captured image and a geometrically transformed image generated by a geometric transformation process on the second captured image becomes equal to or less than a predefined threshold.

(9) The image processing device according to any one of (4) to (8), further including:

an object recognizing section that performs subject recognition with use of the second captured image, and identifies an image region of a speed detection target a moving speed of which is to be detected, in which

the distortion calculating section regards, as the subject, the speed detection target identified by the object recognizing section, and calculates the image distortion by using an image of the image region of the speed detection target.

(10) The image processing device according to (9), in which

the distortion calculating section calculates respective image distortions of plural speed detection targets identified by the object recognizing section, while switching the speed detection targets in units of lines, and

the moving-speed detecting section detects the moving speed of each of the speed detection targets in units of lines on the basis of the image distortions sequentially calculated by the distortion calculating section.

(11) The image processing device according to (9), in which

the object recognizing section detects a still object as the speed detection target, and

the moving-speed detecting section detects a moving speed relative to the still object, on the basis of a distortion amount of an image distortion of the still-object.

(12) The image processing device according to any one of (2) to (11), further including:

a first imaging section that acquires a first captured image by performing exposure of lines at different timings;

a second imaging section that acquires a second captured image by performing exposure of lines at one timing; and

a distance measuring section that measures the distance to the subject.

(13) The image processing device according to (12), in which

the first imaging section and the second imaging section are disposed in such a way that a parallax between the first captured image and the second captured image is less than a predetermined value and that the first captured image and the second captured image are equal in pixel size of a region of the same subject.

### REFERENCE SIGNS LIST

10: Speed detection system
20: Imaging device
21g, 21r: Imaging section
22: Half mirror
30: Image processing device
31: Database section
32: Object recognizing section
33: Distortion calculating section
34: Distance measuring section
35: Moving-speed detecting section

1. An image processing device comprising:
a moving-speed detecting section that detects a moving speed of a subject on a basis of a subject image distortion generated in a first captured image obtained by exposure of lines at different timings.

2. The image processing device according to claim 1, wherein
the moving-speed detecting section detects the moving speed of the subject on a basis of a view angle of the first captured image, a distance to the subject, and a distortion amount of the image distortion.

3. The image processing device according to claim 2, wherein
the moving-speed detecting section detects the moving speed of the subject in each line on a basis of the distortion amount of the image distortion in each line.

4. The image processing device according to claim 1, further comprising:
a distortion calculating section that calculates the subject image distortion, wherein,
by using a second captured image obtained by exposure of lines at one timing, the distortion calculating section calculates a distortion amount of the subject image distortion generated in the first captured image.

5. The image processing device according to claim 4, wherein
the distortion calculating section calculates the distortion amount by using an amount of a position deviation between line images of the subject in an identical position in the first captured image and the second captured image.

6. The image processing device according to claim 5, wherein
the distortion calculating section uses, as the distortion amount, a difference between an amount of a position deviation between line images of the subject in a first position in the first captured image and the second captured image and an amount of a position deviation between line images of the subject in a second position at which the exposure timing is later than that at the first position, in the first captured image and the second captured image.

7. The image processing device according to claim 6, wherein
the distortion calculating section adjusts a line interval between the first position and the second position according to a size of a subject image.

8. The image processing device according to claim 4, wherein
the distortion calculating section calculates the distortion amount on a basis of a geometric transformation as a result of which a difference between the first captured image and a geometrically transformed image generated by a geometric transformation process on the second captured image becomes equal to or less than a predefined threshold.

9. The image processing device according to claim 4, further comprising:
an object recognizing section that performs subject recognition with use of the second captured image, and identifies an image region of a speed detection target a moving speed of which is to be detected, wherein
the distortion calculating section regards, as the subject, the speed detection target identified by the object recognizing section, and calculates the image distortion by using an image of the image region of the speed detection target.

10. The image processing device according to claim 8, wherein
the distortion calculating section calculates respective image distortions of plural speed detection targets identified by the object recognizing section, while switching the speed detection targets in units of lines, and
the moving-speed detecting section detects the moving speed of each of the speed detection targets in units of lines on a basis of the image distortions sequentially calculated by the distortion calculating section.

11. The image processing device according to claim 8, wherein
the object recognizing section detects a still object as the speed detection target, and
the moving-speed detecting section detects a moving speed relative to the still object, on a basis of a distortion amount of an image distortion of the still-object.

12. The image processing device according to claim 2, further comprising:
a first imaging section that acquires a first captured image by performing exposure of lines at different timings;
a second imaging section that acquires a second captured image by performing exposure of lines at one timing; and
a distance measuring section that measures the distance to the subject.

13. The image processing device according to claim 12, wherein
the first imaging section and the second imaging section are disposed in such a way that a parallax between the first captured image and the second captured image is less than a predetermined value and that the first captured image and the second captured image are equal in pixel size of a region of the same subject.

14. An imaging processing method comprising:
causing a moving-speed detecting section to detect a moving speed of a subject on a basis of a subject image distortion generated in a first captured image obtained by exposure of lines at different timings.

15. A program for causing a computer to detect a moving speed by using a captured image, the program being configured to cause the computer to execute:
a procedure of acquiring a first captured image obtained by exposure of lines at different timings;
a procedure of calculating a subject image distortion generated in the first captured image; and
a procedure of detecting a moving speed of the subject on a basis of the calculated image distortion.
